(19) United States
(12) Patent Application Publication
(10) Pub. No.: US 2017/0225549 A1
(43) Pub. Date: Aug. 10, 2017

(54) ROLLER SUNSHADE DEVICE

(71) Applicant: YACHIYO INDUSTRY CO., LTD., Sayama-shi, Saitama (JP)

(72) Inventors: Toshiyuki KANAI, Saitama (JP); Sou TAKAKURA, Saitama (JP); Hirotaka KAMIOKA, Saitama (JP)

(21) Appl. No.: 15/311,727

(22) PCT Filed: May 12, 2015
(86) PCT No.: PCT/JP2015/063592

§ 371 Date: Nov. 16, 2016

(30) Foreign Application Priority Data
May 22, 2014 (JP) 2014-106215

(51) Int. Cl. B60J 7/00

(52) U.S. Cl. CPC B60J 7/0015

(57) ABSTRACT

A roller sunshade device suppressing the drooping of both end portions in a width direction of a shad. The roller sunshade device includes an extendable and retractable shade, and a tension providing unit providing greater tension to both end portions in the width direction of the shade than to a center portion thereof. The roller sunshade device also includes a handle member including a support portion supporting a distal end portion of the shade, wherein at least one of the support portion of the handle member and the distal end portion of the shade is curved prior to assembly thereof, and when the distal end portion of the shade is assembled to the support portion of the handle member, greater tension is provided to the both end portions in the width direction of the shade than to the center portion thereof.

### TECHNICAL FIELD

The present invention relates to a roller sunshade device provided to a roof of a vehicle.

### BACKGROUND ART

There is known a roller sunshade device that lets in or blocks out light through a compartment opening provided to a fixed roof of a vehicle. For example, Patent Literature 1 describes a conventionally known structure of such a roller sunshade device. The roller sunshade device of Patent Literature 1 has left and right guide rails provided on the respective sides of a roof opening, a shade that opens or closes the roof opening, a retractor that rolls up the shade, and a handle member which is attached to a tip end portion of the shade and is slidable along the left and right guide rails. The handle member has a support portion formed at its rear end to support the tip end portion of the shade across the width thereof.

A roll-up spring provided in the retractor causes predetermined tensile forces to act on the shade in a roll-up direction. These tensile forces prevent the shade from slackening (sagging). In the conventional roller sunshade device, the tip end portion of the shade and the support portion of the handle are both formed linearly in the width direction.

### CITATION LIST

### Patent Literature

Patent Literature 1: Japanese Patent Application Publication No. 2011-079437

### SUMMARY OF INVENTION

### Technical Problem

FIG. 6 is a perspective view of a conventional roller sunshade device. As shown in FIG. 6, when an opening A1 of a roof A is closed with a shade 30 of the conventional roller sunshade device, widthwise end portions 32A of the shade 30 may slacken at a center portion in a front-rear direction of the shade 30. The slackening is thought to occur because, although the retractor 5 causes the predetermined tensile forces to act on the shade 30, it is difficult for the tensile forces to act on the widthwise end portions 32A of the shade 30.

A conceivable countermeasure against the above problem is, for example, to support the widthwise end portions 32A of the shade 30 on left and right guide rails 4, 4. This may, however, complicate the structure, increase the number of components, and furthermore, lower operability as a result of increased resistance against unrolling and rolling-up operations.

The present invention has been created to solve such problems, and has an object to provide a roller sunshade device capable of advantageously preventing a shade from slackening at widthwise end portions thereof.

### Solution to Problem

To solve the foregoing problems, a roller sunshade device of the present invention includes a stretchable shade and a tensile force application part that applies a larger tensile force to widthwise end portions of the shade than to a widthwise center portion of the shade.

According to the above configuration, the widthwise end portions of the shade are pulled in an unroll direction more strongly than the widthwise center portion of the shade because a larger tensile force is applied to the end portions than to the center portion. This can advantageously prevent the shade from slackening at the widthwise end portions thereof.

Preferably, the roller sunshade device includes a handle member having a support portion that supports a tip end portion of the shade, and the tensile force application part is configured such that: at least one of the support portion of the handle member and the tip end portion of the shade forms a curve in a pre-assembled state; and when the tip end portion of the shade is assembled to the support portion of the handle member, a larger tensile force is applied to the widthwise end portions of the shade than to the widthwise center portion of the shade.

According to the above configuration, the tensile force application part can have a simple structure because it is only necessary to form either one of the support portion of the handle member and the tip end portion of the shade into a curved shape. Thus, the prevention of slackening of the shade can be achieved without complicating the structure, increasing the number of components, or lowering operability as a result of increased resistance against unrolling and rolling-up operations.

Preferably, the tip end portion of the shade includes an accommodation portion formed by folding back and sewing an edge, and a core material inserted into the accommodation portion.

According to the above configuration, the tip end portion of the shade can advantageously maintain its state of being assembled to the handle member even though the widthwise end portions of the shade are pulled in the unroll direction more strongly than the widthwise center portion of the shade.

### Advantageous Effects of Invention

The roller sunshade device of the present invention can advantageously prevent the shade from slackening at the widthwise end portions thereof.

### BRIEF DESCRIPTION OF DRAWINGS

FIGS. 1A and 1B are diagrams showing a roller sunshade device according to an embodiment of the present invention, FIG. 1A being a schematic perspective view and FIG. 1B schematically showing, with a grid, how a shade stretches.

FIG. 2A is a plan view showing the shade and a handle member, FIG. 2B is a sectional view showing the shade and a retractor, and FIG. 2C is a sectional view showing how the shade is supported by the handle member.

FIG. 3 is a plan view showing the magnitudes of tensile forces acting on the shade.

FIG. 4A is a plan view showing a shade and a handle member according to a modification, and FIG. 4B is a plan view showing the magnitudes of tensile forces acting on the shade.

FIGS. 5A and 5B are plan views showing shades and handle members according other modifications.

FIG. 6 is a perspective view showing a conventional roller sunshade device.

### DESCRIPTION OF EMBODIMENTS

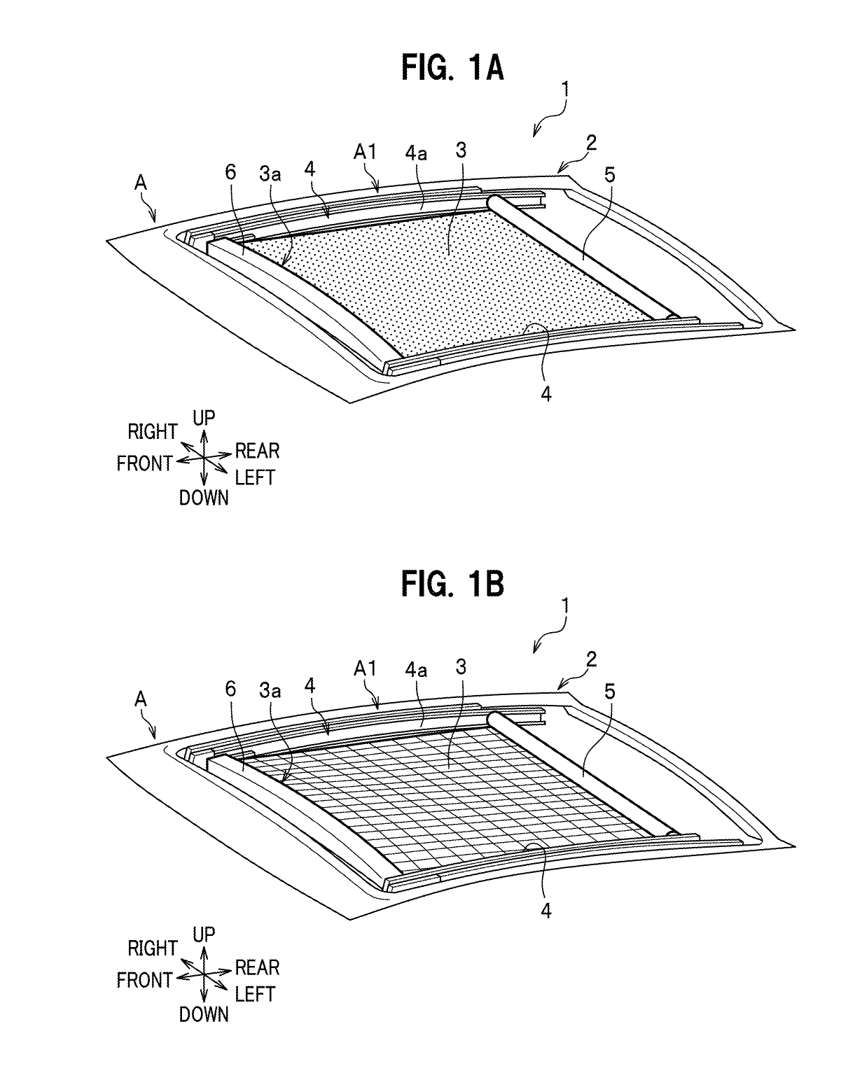

An embodiment of a roller sunshade device according to the present invention is described hereinbelow with reference to the drawings. Note that directions referred to in the following description as “front”, “rear”, “left”, “right”, “up”, and “down” are based on the directions shown in FIG. 1. Furthermore, a front-rear direction herein corresponds to forward and backward directions in which a vehicle travels.

A roller sunshade device 1 of the present embodiment is, as shown in FIGS. 1A and 1B, a device that lets in or blocks out light through an opening portion A1 formed in a roof A of a vehicle (not shown) and surrounded by a frame body 2. The roller sunshade device 1 can open and close the opening portion A1 of the roof A by sliding a shade 3, placed at the opening portion A1, in the front-rear direction. For example, a glass plate is fitted in the roof A to allow light in.

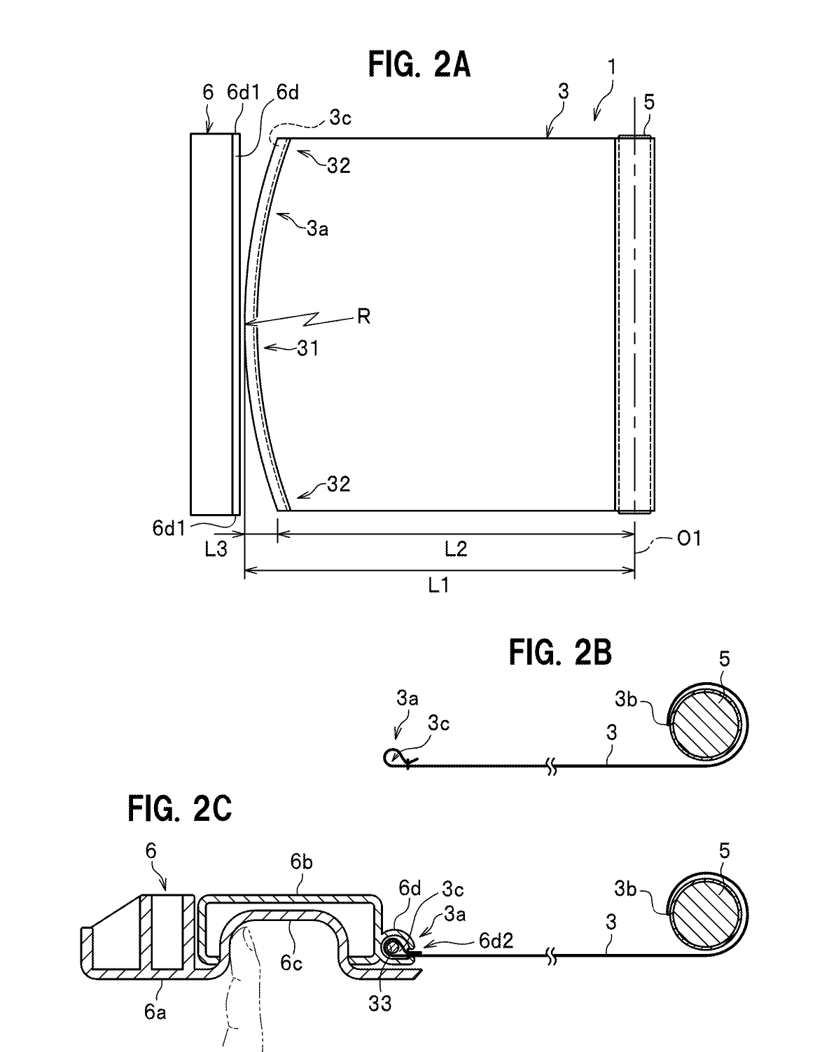

The roller sunshade device 1 includes guide rails 4, 4 provided respectively on left and right side portions of the opening portion A1 of the vehicle, the shade 3 configured to cover the opening portion A1, and a retractor 5 placed inside the frame body 2 on a rear side thereof and configured to roll up the shade 3. A handle member 6 is attached to a tip end portion 3a of the shade 3. A rear end portion 3b of the shade 3 (see FIG. 2B) is fixed to an outer circumferential surface of the retractor 5. Widthwise end portions of the handle member 6 are provided with sliders (not shown). The sliders are supported by the left and right guide rails 4, 4, respectively.

The retractor 5 includes a roll-up spring (not shown). The roll-up spring causes predetermined tensile forces to act on the shade 3 in a roll-up direction.

In the roller sunshade device 1, the shade 3 slides along the left and right guide rails 4, 4 in the front-rear direction, getting unrolled from the retractor 5 or rolled up by the retractor 5.

The roller sunshade device 1 may be provided with a driving device for rolling up and unrolling the shade 3. In this case, for example, the driving device is configured to drive a driving motor (not shown) to rotate forward or backward so that a cable fixed to the handle member 6 moves frontward or rearward along the guide rails 4, 4, causing the shade 3 to be unrolled from the retractor 5 or rolled up by the retractor 5.

The left and right guide rails 4, 4 are placed along the left and right side portions of the frame body 2, respectively, at positions between, for example, the vehicle's compartment ceiling (not shown) and an outer plate of the roof of the vehicle. The left and right guide rails 4, 4 are formed to be symmetric to each other and extend in the front-rear direction. The guide rails 4, 4 are formed from a material for extrusion molding, e.g., an aluminum alloy.

A rail groove 4a is formed on an inner side surface of each guide rail 4. The sliders (not shown) provided to side portions of the handle member 6 are slidably inserted into the respective rail grooves 4a. The sliders are slidable in the front-rear direction by being guided by the rail grooves 4a.

The shade 3 is formed from a stretchable fabric body. As shown in FIG. 2A, the tip end portion 3a of the shade 3 forms a curve having a predetermined radius of curvature R in such a manner that a widthwise (left-right direction) center portion 31 of the shade 3 protrudes in an unroll direction (frontward) relative to widthwise end portions 32, 32. Thereby, a length L2 of the shade 3 from an axis of the retractor 5 to a tip end of each end portion 32 is shorter than a length L1 of the shade 3 from the axis O1 of the retractor 5 to a tip end of the center portion 31.

As shown in FIG. 2B, the tip end portion 3a of the shade 3, which forms the aforementioned curve having the radius of curvature R, has its edge made into a tubular shape by being folded back, sewn, and distended. An accommodation portion 3c is formed inside the distended tubular portion. A solid-cylindrical core material 33 made of a metal or resin is inserted into the accommodation portion 3c. The core material 33 is long enough to be inserted through substantially the entire accommodation portion 3c in the width direction. The outer diameter of the core material 33 is larger than an opening dimension of an opening 6d2 to be described later. The shape of the core material 33 before being inserted into the accommodation portion 3c is linear in the present embodiment, but may be curved instead.

As shown in FIG. 2A, the handle member 6 extends in the width direction of the shade 3 and curves upward with its widthwise center being situated highest. The handle member 6 has a support portion 6d formed at a rear portion thereof, the support portion 6d extending linearly in the width direction. As shown in FIG. 2C, the support portion 6d is shaped substantially like the letter C in a side view, and has an opening 6d1 (see FIG. 2A) which opens to each side and the opening 6d2 which opens to the rear and extends in the width direction. The tip end portion 3a having the core material 33 inserted therein can be put inside the support portion 6d through the opening 6d1 and the opening 6d2 at the rear end. In other words, the support portion 6d is capable of accommodating the tip end portion 3a having the core material 33 inserted therein, and serves to hold the tip end portion 3a so that the tip end portion 3a will not come off rearward.

As shown in FIG. 2C, the handle member 6 is formed by assembly of an upper member 6b onto a lower member 6a. A finger-placement indentation portion 6c is opened and formed in a lower surface of the lower member 6a so that a user can insert and place their finger for operation. The upper member 6b is assembled to the lower member 6a in such a manner as to cover the finger-placement indentation portion 6c from above. The aforementioned support portion 6d is integrally provided to a rear end portion of the upper member 6b.

In the roller sunshade device 1 thus configured, to connect the shade 3 to the handle member 6, the linear core material 33 is inserted into the accommodation portion 3c of the shade 3, and then, as shown in FIG. 2C, the accommodation portion 3c and the core material 33 are inserted into the support portion 6d through the opening 6d1 of the support portion 6d (see FIG. 2A). Alternatively, the tip end portion 3a of the shade 3 may be put inside the support portion 6d of the handle member 6 first, and then the core material 33 may be inserted into the accommodation portion 3c of the tip end portion 3a from the opening 6d1 of the support portion 6d. Thereby, the core material 33 allows the tip end portion 3a of the shade 3 to be supported in, and not to come off from, the support portion 6d of the handle member 6. The shade 3 curves upward in conformity with the shape of the handle member 6.

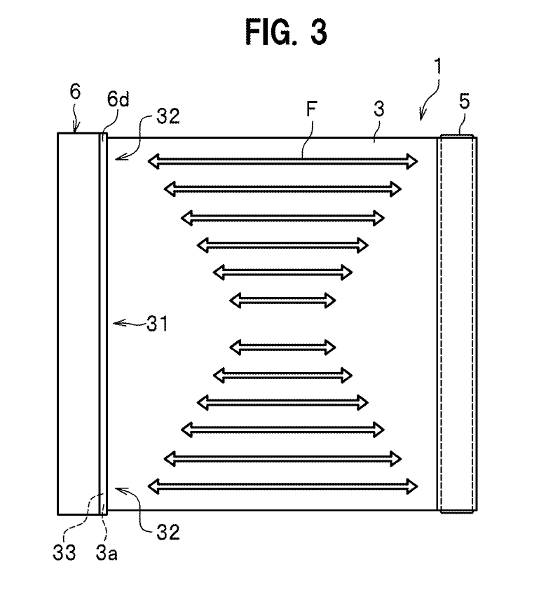

As shown in FIG. 2A, since the tip end portion 3a of the shade 3 has the radius of curvature R, the length L2 from the axis O1 of the retractor 5 to the tip end of each end portion 32 is shorter than the length L1 from the axis O1 of the retractor 5 to the tip end of the center portion 31. Thus, the center portion 31 and each widthwise end portion 32 differ in length by a length L3, which is a length obtained by subtraction of L2 from L1. When the curved tip end portion 3a is supported by the support portion 6d of the handle member 6 which is linear in the width direction, as shown in FIG. 3, the widthwise end portions 32, 32 of the shade 3 are pulled in the front-rear direction more strongly than the widthwise center portion 31 of the shade 3. This can advantageously prevent the shade 3 from slackening at the widthwise end portions 32, 32, or more specifically, center portions of the end portions 32, 32 in the front-rear direction (see FIGS. 1A and 1B). The size of each white outlined arrow in FIG. 3 represents the magnitude of a tensile force F in the front-rear direction. Thus, due to the curved tip end portion 3a, the tensile force F increases gradually from the widthwise center portion 31 to the widthwise end portions 32, 32.

The shade 3 is formed of a stretchable fabric body, and is therefore stretchable flexibly in the width direction. This makes it less likely for the shade 3 to have wrinkles or the like in the width direction and thus allow the shade 3 to have an aesthetic finish when supported in the handle member 6.

The “tensile force application part” in Claims applies a larger tensile force to the widthwise end portions 32, 32 of the shade 3 than to the widthwise center portion 31 of the shade 3, and in the present embodiment, is formed by the curved tip end portion 3a of the shade 3 and the linear support portion 6d of the handle member 6.

According to the roller sunshade device 1 of the present embodiment described above, the curved tip end portion 3a assembled to the support portion 6d of the handle member 6 causes a larger tensile force F to be applied to the widthwise end portions 32, 32 of the shade 3 than to the widthwise center portion 31 of the shade 3, making the end portions 32, 32 pulled in the front-rear direction more strongly than the center portion 31. This can advantageously prevent the shade 3 from slackening at the widthwise end portions 32, 32 thereof.

The tensile force application part can be configured in a simple manner because it is only necessary to form the tip end portion 3a of the shade 3 into a curved shape. In other words, the prevention of slackening of the shade 3 can be achieved without complicating the structure, increasing the number of components, or lowering operability as a result of increased resistance against unrolling and rolling-up operations.

The tip end portion 3a of the shade 3 has the core material 33 inserted into the accommodation portion 3c formed inside the tip end portion 3a, and therefore can advantageously maintain its state of being assembled to the handle member 6 even though the widthwise end portions 32, 32 of the shade 3 are pulled in the unroll direction more strongly than the widthwise center portion 31 of the shade 3.

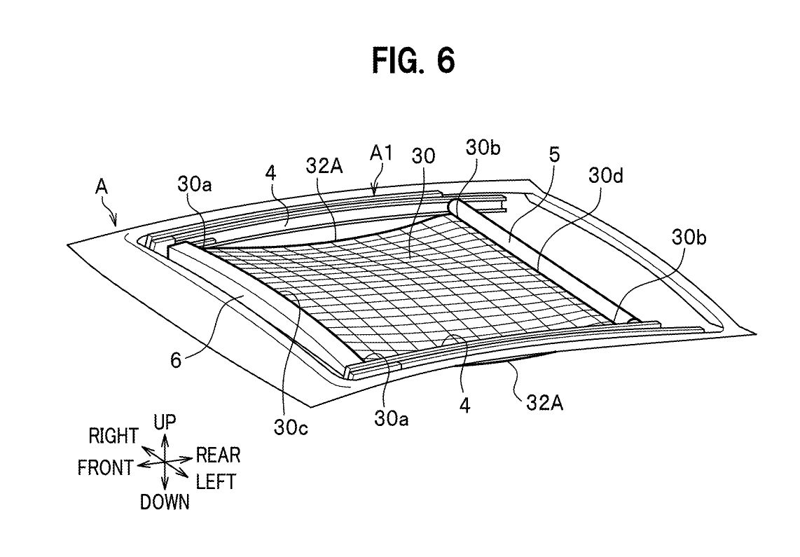

The handle member 6 may be formed straight without curving upward, but when formed to curve upward like in the present embodiment, a larger vehicle compartment space (head clearance) can be provided. However, the handle member 6 formed to curve upward poses a problem in that, as shown in FIG. 6, the widthwise end portions 32A of the shade 3 are more likely to slacken because the distance between reference numerals 30a and 30b for each widthwise end portion 32A of the shade 30 is shorter than the distance between reference numerals 30c and 30d for the widthwise center portion of the shade 30. Forming the retractor 5 to curve upward in conformity with the shape of the handle member 6 can prevent the shade 30 from slackening at the widthwise end portions 32A, but complicates the structure.

In this respect, the roller sunshade device 1 including the tensile force application part of the present embodiment can increase the vehicle compartment space and also make the entire shade 3 taut with a simple structure.

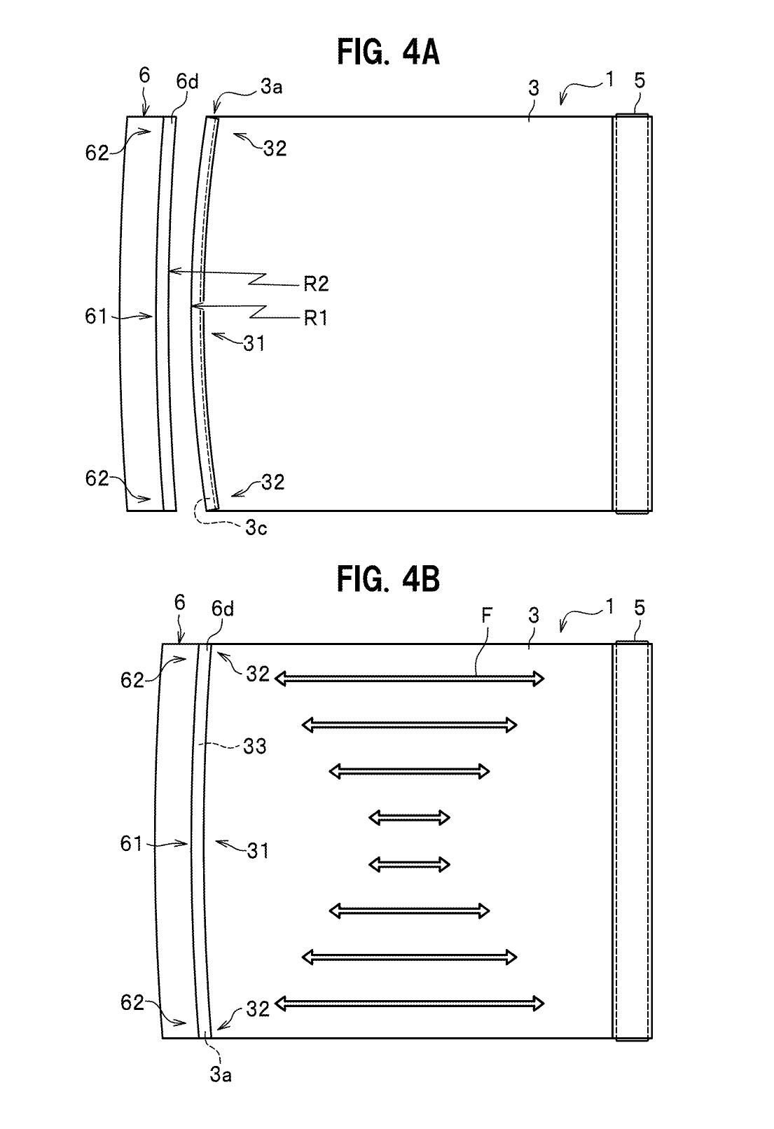

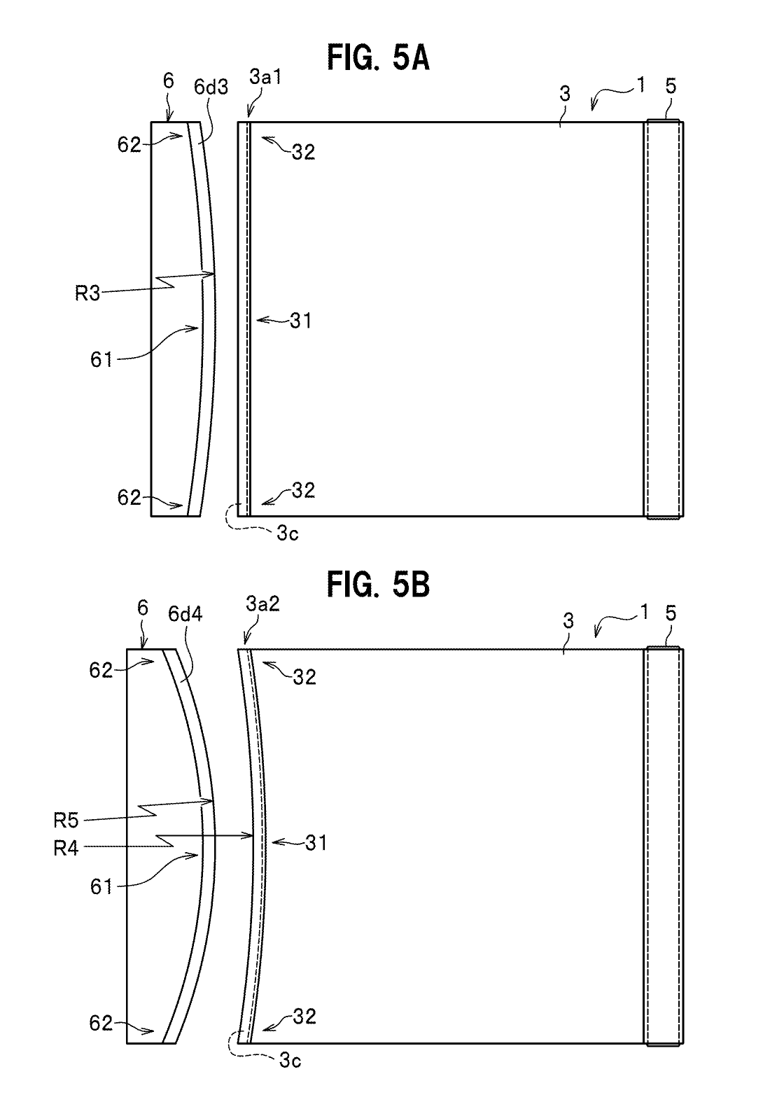

FIGS. 4A, 4B, 5A, and 5B show modifications of the roller sunshade device 1. In the roller sunshade device 1 shown in FIGS. 4A and 4B, the support portion 6d of the handle member 6 forms a curve having a predetermined radius of curvature R2 in such a manner that a widthwise (left-right direction) center portion 61 recesses in the unroll direction (frontward) relative to widthwise end portions 62, 62.

The relation between a radius of curvature R1 of the tip end portion 3a of the shade 3 and the radius of curvature R2 of the handle member 6 (the support portion 6d) is set such that “the radius of curvature R1<the radius of curvature R2”. Due to this configuration, when the tip end portion 3a of the shade 3 is assembled to the support portion 6d, the widthwise end portions 32, 32 of the shade 3 are pulled in the front-rear direction more strongly than the widthwise center portion 31 of the shade 3. This can advantageously prevent the shade 3 from slackening at the widthwise end portions 32, 32 thereof. Since the radius of curvature R1<the radius of curvature R2, the tensile force F acting on the shade 3 gradually increases from the widthwise center portion 31 to the widthwise end portions 32, 32 in the above configuration as well, as shown in FIG. 4B.

In the roller sunshade device 1 shown in FIG. 5A, a tip end portion 3a1 of the shade 3 is formed straight in the width direction, while a support portion 6d3 of the handle member 6 forms a curve having a predetermined radius of curvature R3 in such a manner that the widthwise (left-right direction) center portion 61 protrudes in the roll-up direction (rearward) relative to the widthwise end portions 62, 62.

Due to this configuration, when the tip end portion 3a1 of the shade 3 is assembled to the support portion 6d3, the widthwise end portions 32, 32 of the shade 3 are pulled in the front-rear direction more strongly than the widthwise center portion 31 of the shade 3. This can advantageously prevent the shade 3 from slackening at the widthwise end portions 32, 32 thereof.

The roller sunshade device 1 shown in FIG. 5B is a further modification of the roller sunshade device 1 shown in FIG. 5A. In this roller sunshade device 1, a tip end portion 3a2 of the shade 3 forms a curve having a predetermined radius of curvature R4 in such a manner that the widthwise (left-right direction) center portion 31 protrudes in the roll-up direction (rearward) relative to the widthwise end portions 32, 32, and a support portion 6d4 of the handle member 6 forms a curve having a predetermined radius of curvature R5 in such a manner that the widthwise (left-right direction) center portion 61 protrudes in the roll-up direction (rearward) relative to the widthwise end portions 62, 62.

The relation between the radius of curvature R4 of the tip end portion 3a2 of the shade 3 and a radius of curvature R5 of the handle member 6 (the support portion 6d) is set such that “the radius of curvature R4>the radius of curvature R5”. Due to this configuration, when the tip end portion 3a2 of the shade 3 is assembled to the support portion 6d4, the widthwise end portions 32, 32 of the shade 3 are pulled in the front-rear direction more strongly than the widthwise center portion 31 of the shade 3. This can advantageously prevent the shade 3 from slackening at the widthwise end portions 32, 32 thereof. Since the radius of curvature R4>the radius of curvature R5, the tensile force F acting on the shade 3 gradually increases from the widthwise center portion 31 to the widthwise end portions 32, 32 in the above configuration as well, although not shown.

In the modification of FIGS. 4A and 4B, the “tensile force application part” in Claims is formed by the curved tip end portion 3a of the shade 3 and the curved support portion 6d of the handle member 6. In the modification of FIG. 5A, the “tensile force application part” in Claims is formed by the straight tip end portion 3a1 of the shade 3 and the curved support portion 6d3 of the handle member 6. In the modification of FIG. 5B, the “tensile force application part” in Claims is formed by the curved tip end portion 3a2 of the shade 3 and the curved support portion 6d4 of the handle member 6.

Although the embodiment of the present invention has been described above, the present invention is not limited to the foregoing embodiment and is modifiable in various ways as follows, for example.

For example, the present invention is not limited to the forgoing configurations in which the tip end portion 3a of the shade 3, the support portion 6d of the handle member 6, etc. have the predetermined radiuses of curvature. Instead, the tip end portion 3a of the shade 3, the support portion 6d of the handle member 6, etc., may partly have a straight area in the width direction as long as the tensile force F applied to the widthwise end portions 32, 32 is larger than that applied to the widthwise center portion 31. In addition, the present invention is not limited to the foregoing configurations in which, for example, the tip end portion 3a of the shade 3 is put inside the support portion 6d of the handle member 6 entirely in the width direction. Instead, the tip end portion 3a of the shade 3 may be put inside the support portion 6d of the handle member 6 partly in the width direction as long as the tensile force F applied to the widthwise end portions 32, 32 is larger than that applied to the widthwise center portion 31.

Moreover, the shade 3 may be formed from a fabric body which is stretchable in the front-rear direction only at its widthwise end portions.

### REFERENCE SIGNS LIST

1 roller sunshade device
3 shade
3a, 3a1, 3a2 tip end portion (tensile force application part)
6 handle member
6d, 6d3, 6d4 support portion (tensile force application part)
31 center portion
32 end portion
33 core material
61 center portion
62 end portion
F tensile force

1. A roller sunshade device comprising:
a stretchable shade;
a handle member having a support portion that supports a tip end portion of the shade across a width thereof; and
a tensile force application part that applies, by way of a structure of connecting the handle member to the tip end portion of the shade, a larger tensile force in an unroll direction of the shade to widthwise end portions of the shade than to a widthwise center portion of the shade.

2. The roller sunshade device according to claim 1, wherein
the tensile force application part is configured such that
at least one of the support portion of the handle member and the tip end portion of the shade forms a curve in a pre-assembled state, and
when the tip end portion of the shade is assembled to the support portion of the handle member, a larger tensile force in the unroll direction of the shade is applied to the widthwise end portions of the shade than to the widthwise center portion of the shade.

3. The roller sunshade device according to claim 2, wherein
the tip end portion of the shade includes
an accommodation portion formed by folding back and sewing an edge, and
a core material inserted into the accommodation portion.
